(19) United States
(12) Patent Application Publication
(10) Pub. No.: US 2023/0061109 A1
(43) Pub. Date: Mar. 2, 2023

(54) Unibody Base Chassis Top Cover for a Portable Information Handling System

(71) Applicant: Dell Products L.P., Round Rock, TX (US)

(72) Inventors: Chiu-Jung Tsen, Hsinchu (TW); Yi-Te Chih, New Taipei City (TW); Hsu-Feng Lee, Taipei (TW)

(73) Assignee: Dell Products L.P., Round Rock, TX (US)

(21) Appl. No.: 17/462,095

(22) Filed: Aug. 31, 2021

(51) Int. Cl. G06F 1/16; G06F 3/01; G06F 3/041

(52) U.S. Cl. CPC G06F 1/1633; G06F 3/016; G06F 3/0414

(57) ABSTRACT

A main housing portion of a portable information handing system. The main housing portion includes: a bottom cover portion; and, a top cover portion coupled to the bottom cover portion, the top cover portion comprising a top portion unibody cover, a clear mesh portion, the clear mesh portion performing a touch sensing operation and a top portion bottom cover, the top portion unibody cover and the clear mesh portion being fastened to the top portion bottom cover to provide a unibody top cover portion.

### BACKGROUND OF THE INVENTION

### Field of the Invention

The present invention relates to information handling systems. More specifically, embodiments of the invention relate to a base chassis top cover for a portable information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a main housing portion of a portable information handing system, comprising: a bottom cover portion; and, a top cover portion coupled to the bottom cover portion, the top cover portion comprising a top portion unibody cover, a clear mesh portion, the clear mesh portion performing a touch sensing operation and a top portion bottom cover, the top portion unibody cover and the clear mesh portion being fastened to the top portion bottom cover to provide a unibody top cover portion.

In another embodiment the invention relates to an information handling system comprising: a processor; a data bus coupled to the processor; and an information handling system chassis housing, the housing comprising a base chassis, the base chassis housing the processor, the base chassis comprising a bottom cover portion; and, a top cover portion coupled to the bottom cover portion, the top cover portion comprising a top portion unibody cover, a clear mesh portion, the clear mesh portion performing a touch sensing operation and a top portion bottom cover, the top portion unibody cover and the clear mesh portion being fastened to the top portion bottom cover to provide a unibody top cover portion.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a perspective view of an example portable information handling system.

FIG. 3 shows a blown-up view of a portable information handling system.

FIG. 4 shows an exploded view of a portion of a base chassis of a portable information handling system.

FIG. 5 shows a perspective view of a portion of a portable information handling system.

FIG. 6 shows a block diagram of a haptic interface system.

FIG. 7 shows a flow chart of a haptic cancelation operation.

### DETAILED DESCRIPTION

Various aspects of the present disclosure include an appreciation that a portable information handling system base chassis use separate trackpad, keyboard and graphic adaptive row. Often these components are provided by different supplies, thus complicating the supply chain process. Additionally, various aspects of the present disclosure include an appreciation that when these components are separate, the integration of these components on the base chassis top portion (i.e., the C-Cover) lead to multiple design constraints that impact the robustness of the base chassis top portion and can lead to more potential failure modes. Various aspects of the present disclosure include an appreciation that it would be desirable to provide a localized haptic feedback for a full palm rest size trackpad as compared to known systems which only provide global haptic that vibrates the entire trackpad. Accordingly, a portable information handling system which includes a unibody base chassis top portion is disclosed which addresses these issues.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

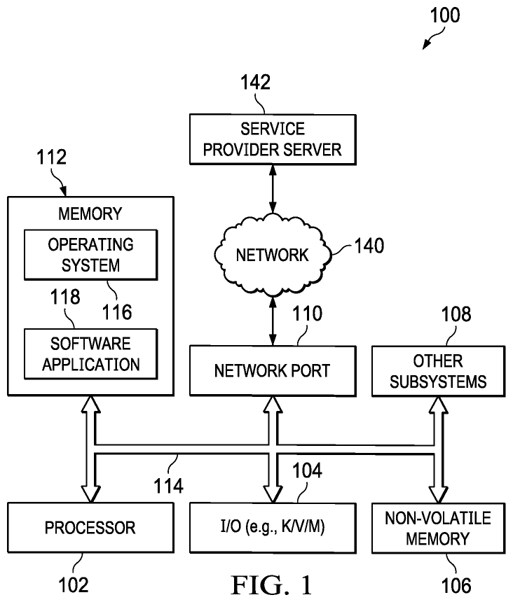

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, a touchpad or touchscreen, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise at least one software application 118. In one embodiment, the information handling system 100 is able to download the software application from the service provider server 142. In another embodiment, the software application 118 is provided as a service from the service provider server 142.

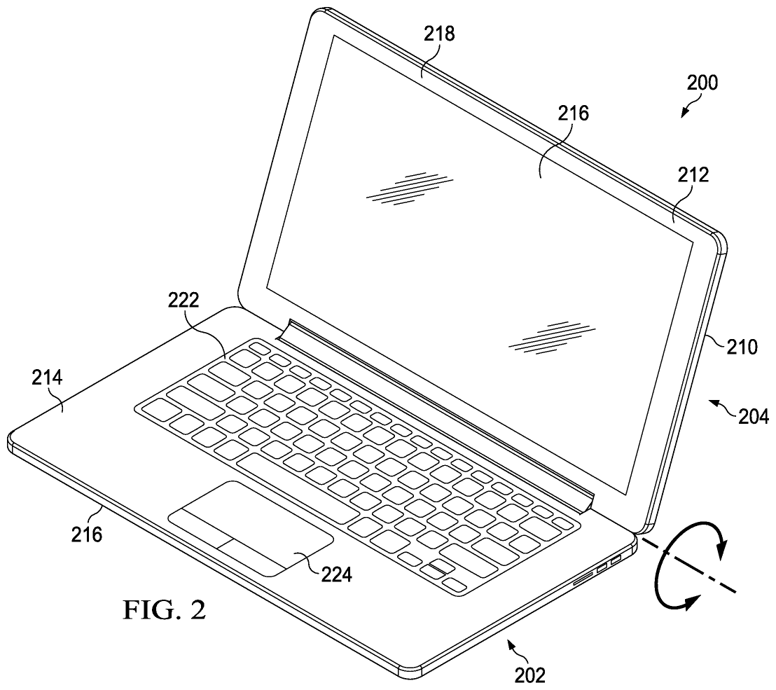

FIG. 2 shows a perspective view of an example portable information handling system chassis 200 such as a tablet type portable information handling system, a laptop type portable information handling system, or any other mobile information handling system. It will be appreciated that some or all of the components of the information handling system 100 may be included within information handling system chassis 200. The portable information handling system 200 chassis includes a base chassis 202 and a display chassis 204 shown in an open configuration. It will be appreciated that a closed configuration would have the display chassis 204 fully closed onto the base chassis 202.

The base chassis 202 or the display chassis 204 of the information handling system 200 may comprise an outer metal case or shell. The information handling system 200 may include a plurality of chassis portions. In various embodiments, the information handling system 200 may include some or all of an A-Cover 210, a B-Cover 212, a C-cover 214 and a D-Cover 216. In various embodiments, the A-Cover 210 and the B-Cover 212 provide the display chassis 204. In various embodiments, the C-Cover 214 and the D-Cover 216 provide the base chassis 202.

In various embodiments, the A-cover 210 encloses a portion of the display chassis 204 of the information handling system 200. In various embodiments, the B-cover 212 encloses another portion of the display chassis 204 of the information handling system 200. In various embodiments, the B-Cover may include a display screen 216 and a bezel 218 around the display screen.

In various embodiments, the C-cover 214 encloses a portion of the base chassis 202 of the information handling system 200. In various embodiments, the C-cover 214 may include, for example, a keyboard 222, a trackpad 224, or other input/output (I/O) device. In various embodiments, certain components of the information handling system such as a mother board are mounted within the C-Cover 214. In various embodiments, the D-cover 216 encloses another portion of the base chassis 202 of the information handling system 200.

When placed in the closed configuration, the A-cover 210 forms a top outer protective shell, or a portion of a lid, for the information handling system 200, while the D-cover 216 forms a bottom outer protective shell, or a portion of a base, for the information handling system. When in the fully closed configuration, the A-cover 210 and the D-cover 216 would be substantially parallel to one another.

In some embodiments, both the A-cover 210 and the D-cover 216 may be comprised entirely of metal. In some embodiments, the A-cover 210 and D-cover 216 may include both metallic and plastic components. For example, plastic components that are radio-frequency (RF) transparent may be used to form a portion of the C-cover 214.

In various embodiments, the display chassis 204 may be movably connected to a back edge of the base chassis 202 via one or more hinges. In this configuration, the hinges allow the display chassis 204 to rotate from and to the base chassis 202 allowing for multiple orientations of the information handling system 200. In various embodiments, the information handling system may include a sensor to detect the orientation of the information handling system and activate or deactivate any number of antenna systems based on the occurrence of any specific orientation. In some embodiments, the information handling system may be a laptop with limited rotation of the display chassis 204 with regard to the base chassis 202, for example up to 180° rotation arc. In other embodiments the information handling system 200 may be a convertible information handling system with full rotation to a tablet configuration.

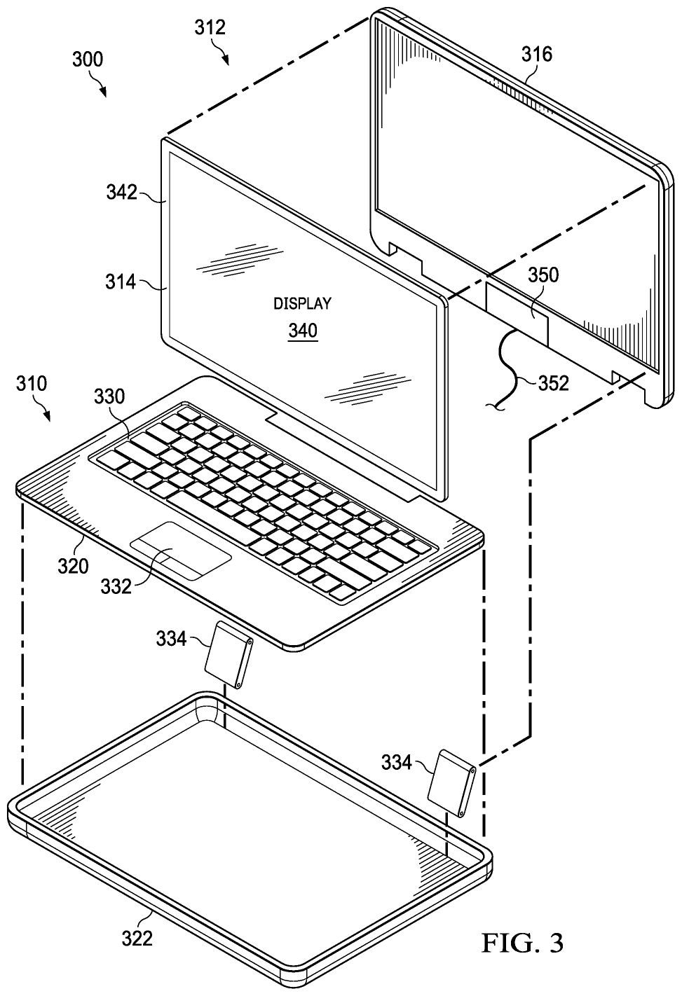

FIG. 3 shows a blown-up view of a portable information handling system 300 having rotationally—coupled housing portions. In the example embodiment, a main housing portion 310 (which corresponds to a base chassis 202) rotationally couples to a lid housing portion 312 (which corresponds to a display chassis 204) to support various configurations to interact with an end user. Main housing portion 310 may hold one or more components of the portable information handling system, including but not limited to processor 102, system bus 114, memory subsystem 112, I/O subsystem 104 and network interface 110 discussed with respect to FIG. 1. Main housing portion 310 includes a top cover portion 320 (which includes the C-Cover 214) and a bottom cover portion 322 (which includes the D-Cover 216). Lid housing portion 312 includes a display cover portion 314 (which includes the B-Cover 212) and a rear display cover portion 316 (which includes the A-Cover 210). The top cover portion 320 may include an integrated keyboard 330 or other I/O devices, such as a trackpad 332 or microphone (not shown). In various embodiments, the keyboard 330 may be mounted to the top of the C-Cover of the main housing portion 310. In various embodiments, the keyboard 330 may be mounted to the underside of the C-Cover of the main housing portion 310.

Lid housing portion 312 is rotationally coupled to main housing portion 310 via at least one hinge assembly 334. Lid housing portion 312 includes display 340 that visually presents information to the user as well as a bezel 342. Display 340 may be a touch panel with circuitry enabling touch functionality in conjunction with a display. In some embodiments, display 340 may be an “infinity edge” or “narrow bezel” display that approaches one or more the edges of lid housing portion 312 such that bezel may be narrow in size (e.g., less than 10 millimeters) on the edges. For example, display 340 is an infinity display with narrow bezels on the top and sides of lid housing portion 312 in the embodiment shown in FIG. 3. In certain embodiments, the side bezel is less than 4 mm (+/−10%) and the top bezel is less than 6 mm (+/−10%).

Lid housing portion 312 may also include timing controller (TCON) 350. Hinge assembly 330 may include cable 352 for communicably coupling one or more components within main housing portion 310 to one or more components within lid housing portion 312. For example, cable 352 may provide communication of graphics information from an I/O subsystem to TCON 350 for generation of visual images for display on display 340. Although a single cable 352 is shown, portable information handling system 300 may include one or more additional cables 352 for communicating components disposed in main housing portion 310 and lid housing portion 312. Placement of cable 352 may be selected based on design considerations, materials or manufacturing cost, material reliability, antenna placement, as well as any other considerations.

Hinge assembly 334 allows main housing portion 310 and lid housing portion 312 to rotate between a plurality of positions. For example, when portable information handling system 300 is not in use, lid housing portion 312 may be closed over the top of main portion 310 such that display 340 and keyboard 330 are protected from unintended use or damage. Rotation of lid housing portion 312 by approximately 90 degrees from main housing portion 310 brings display 340 in a raised “clamshell” position relative to keyboard 330 so that an end user can make inputs to keyboard 330 or touch panel portion of display 340 while viewing display 340. In some embodiments, clamshell position may represent lid housing portion 312 open between approximately 1 and 180 degrees from main housing portion 310. Rotation of lid housing portion 312 between approximately 180 and 359 degrees from main housing portion 310 may place portable information handling system 300 in “tablet stand” and/or “tent” positions. In tablet stand and tent positions, the user may make inputs via touch panel portion of display 340 while viewing display 340. A full 360 degree rotation of main housing portion 310 relative to lid housing portion 312 provides a tablet configuration having display 340 exposed to accept touch inputs. In any position, user inputs may be communicated to an I/O subsystem or a processor of the portable information handling system 300 for processing, and then updated information may be communicated back via cable 352 to display 340 for displaying to the user. Hinge assembly 334 may be comprised of one or more discrete hinges or a unified assembly of hinges.

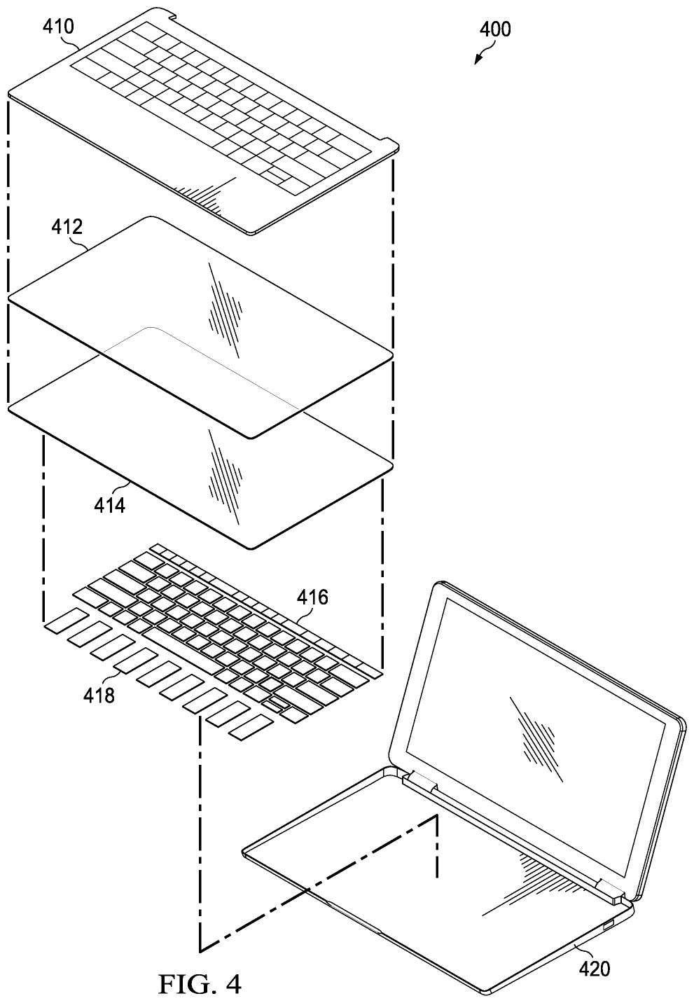

FIG. 4 shows an exploded view of a portion of a portable information handling system 400 which includes a unibody base chassis top cover. More specifically, the portable information handling system 400 includes a top portion unibody cover portion 410, a clear mesh portion 412, a force sensing capacitance (FSC) film portion 514, an adaptive row display portion 516, a piezo portion 518 and a top portion bottom cover 420. In certain embodiments, one or more of the top portion unibody cover portion 410, the clear mesh portion 412, the FSC film portion 414, the adaptive row display portion 416, the piezo portion 418 and the top portion bottom cover 420 provide a unibody base chassis top cover. In certain embodiments, the unibody base chassis top cover corresponds to a C-Cover of a portable information handling system.

In certain embodiments, the top portion unibody cover portion 410 is constructed of a clear material. In certain embodiments the top portion unibody cover portion 410 include back printing (i.e., printing on an underside of the top portion unibody cover portion 410). In certain embodiments, the back printing includes representations of a plurality of keys of a keyboard. In certain embodiments, the underside (i.e., the bottom) of the top portion unibody cover portion 410 is substantially flat. In certain embodiments, the top portion unibody cover portion 410 includes keyboard grooves. In certain embodiments, the keyboard grooves include lattice grooves (i.e., grooves between the keys). In various embodiments, the keys of the keyboard can be made all flat without an indication of key boundary, can be machined to include recessed grooves, or can be molded with rubber filling the grooves. In certain embodiments, the keyboard grooves are formed by one or more of a computer numerical control (CNC) machining process and molding the grooves.

In certain embodiments, the clear mesh portion 412 is constructed of a clear metal mesh film. In certain embodiments, the clear mesh portion 412 performs a touch sensing operation. In certain embodiments, the clear mesh portion 412 performs a pen sensing operation. In certain embodiments, the clear mesh portion performs an active electrostatic (AES) pen sensing operation.

In certain embodiments, the film portion includes a force sensing film. In certain embodiments, the force sensing film includes a set of pressure sensor arrays. In certain embodiments, the film portion 414 is constructed of a force sensing capacitive film. In certain embodiments, the film portion 414 is constructed of a force sensing resistive film. In certain embodiments, the film portion 414 performs a force sensing operation. In certain embodiments, the film portion 414 performs a tactile sensing operation. As used herein, a tactile sensing operation measures information arising from a physical interaction with the unibody base chassis top cover.

In certain embodiments, the adaptive row display portion 416 is configured to adaptively present a row of icons. In certain embodiments, each icon of the row of icons may be actuated to perform a particular function.

In certain embodiments, the piezo portion 418 includes one or more piezo devices. In certain embodiments, the piezo portion 418 performs a haptic function. As used herein, a haptic function may be defined as creating an experience of touch by providing a force (e.g., a vibration) in response to interaction with the unibody base chassis top cover. In certain embodiments, the set of piezo devices provide a vibration response to touch. In certain embodiments, the force is location specific. In certain embodiments, the force corresponds to the location of the interaction with the unibody base chassis top cover.

In certain embodiments, the top portion bottom cover 420 is the base to which one or more of the top portion unibody cover portion 410, the clear mesh portion 412, the film portion 414, the adaptive row display portion 416 and the piezo portion 418 are attached. In certain embodiments, one or more of the top portion unibody cover portion 410, the clear mesh portion 412, the film portion 414, the adaptive row display portion 416, and the piezo portion 418 are attached via an adhesive such as a pressure sensitive adhesive.

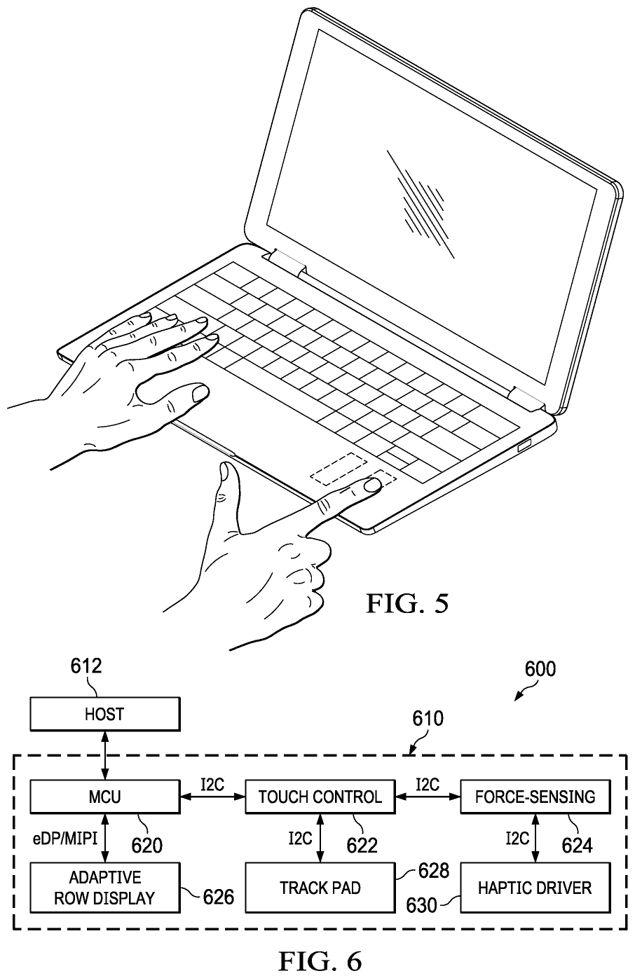

FIG. 5 shows a perspective view of a portion of a portable information handling system which includes a unibody base chassis top cover. In certain embodiments, the unibody base chassis top cover performs a haptic cancelation operation. The haptic cancelation operation ensures the haptic is concentrated around where user clicked to deliver a localized haptic experience without causing confusion on the rest of the unibody base chassis top cover.

For example, when a body part of a user (e.g., a finger or a hand) is resting on the unibody base chassis top cover, not haptic response is generated. Alternately, when a body part of a user (e.g., a finger or a hand) actuates (e.g., clicks) a location on the unibody base chassis top cover portion, a haptic response is generated. In certain embodiments, the location may correspond to a key of the keyboard. In certain embodiments, the haptic response is generated by a piezo from the set of piezo devices which is located closes to the point of actuation. In certain embodiments, certain portions of the unibody base chassis top cover portion may be configured to cancel a haptic response. In certain embodiments, the haptic response is canceled by reversing a phase vibration of certain piezos of the set of piezos.

FIG. 6 shows a block diagram of a haptic interface system architecture 600. More specifically, the haptic interface system architecture 600 includes a haptic interface system 610 which interacts with a host 612 of an information handling system such a processor 102 of information handling system 100. In certain embodiments, the haptic interface system 610 is an example of an I/O device 104 of the information handling system 100.

The haptic interface system 610 includes a micro control unit 620, a touch controller 622, a force sensing device 624, an adaptive row display 626, a track pad 628 and a haptic driver 630. In certain embodiments, the haptic interface system 610 can also include a keyboard such as when the keyboard is included within a flat top portion unibody cover portion. In certain embodiments, the micro control unit 620, touch controller 622, force sensing device 624, track pad 628 and haptic driver 630 communicate via a serial communication bus such as an I2C type communication bus. In certain embodiments, the micro control unit 620 and the adaptive row display communicate via a processor interface such as an embedded display port/mobile industry processor interface.

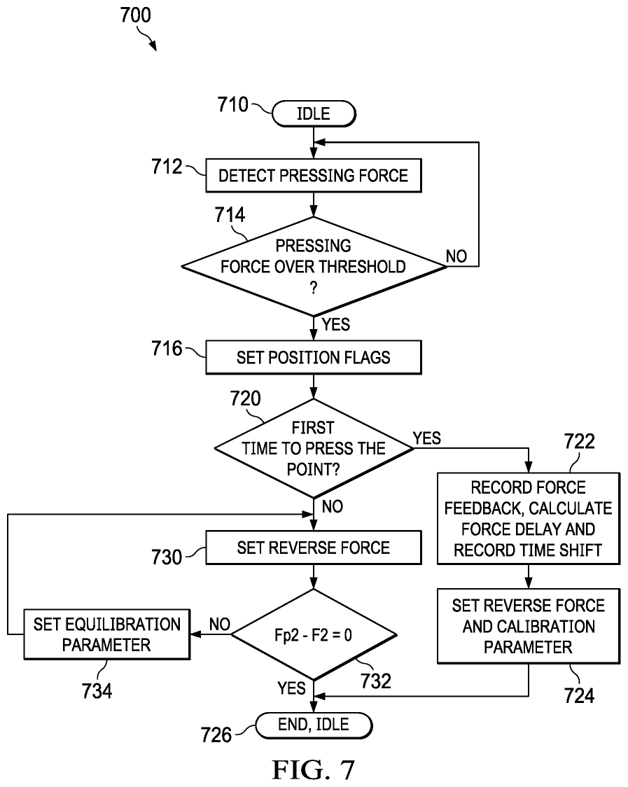

FIG. 7 shows a flow chart of a haptic cancelation operation 700. The haptic cancelation operation 700 transitions from an idle state 710 upon detection of a pressing force at step 712. Next a determination is made whether the force is greater than a predetermined threshold at step 714. If not, then the operation returns to step 712 continue to detect when a pressing force occurs. In various embodiments, the haptic cancelation operation 700 includes one or both of a first time press portion which is used to create the reverse wave parameters for cancelation and another time press portion which directly triggers cancelation of the haptic using the reverse wave form parameters generated during the first time press portion. In certain embodiments, the first time press portion is a pre-setup/calibration operation which may be performed during fabrication of the system.

If so, then the operation 700 sets a position flag value for the position that received the force, which is referred to as the trigger point, as well as a position flag value for the position surrounding the position that the force was received at step 716. Specifically, the position flag for the trigger point is set as PF=1 and the position flag for the surrounding position is set as FF=2. In certain embodiments, the trigger point position and the surrounding positions are based upon the locations of the piezo which is actuated as well as surrounding piezos.

Next at step 720, the operation determines whether the pressing force detection was the first time for the particular position. If so, then the operation proceeds record a force feedback value, calculate a force decay value and record a time shift value at step 722. More specifically, the force feedback value, F2, is recorded for the particular location such that F2=2. The force decay value, Fd, is calculated as Fd=F2/F1. The time shift, Ts is recorded from time T1 to time T2 where time T1 corresponds to when the Flag Pf=1 and time T2 corresponds to when the Flag Pf=2.

Next, at step 724 the operation proceeds to set a reverse force value and a calibration parameter. More specifically, the reverse force value, Fp3, at position flag Pf3 is provided from the piezo actuator while the time equals T3. The reverse force value Fp3 is set as Fp3=F2×fd. The time value T3 is set as T3=T2+Tf. Tf represents a time gap where the initial haptic wave triggers from a first piezo to another piezo, which triggers the reverse force for cancelation. Additionally, the calibration parameter, Fc2, is set to zero (Fc2=0). Next, at step 726 the operation 700 ends and returns to an idle state.

If it is determined that the pressing force detection was not the first time for the particular position, then the operation proceeds to set a reverse force value at step 730. More specifically, the reverse force value, Fp2, at position flag Pf2 is provided from the piezo actuator while the time equals T2. The reverse force value Fp2 is set as Fp2=F1×Fd+fc2. The time value t2 is set as T2=T1+Ts. Next, the operation 700 determines whether Fp2−F2 equals zero (Fps−F2=0) at step 732. If yes, then the operation 700 ends and returns to an idle state at step 726. If no, then the operation sets a calibration parameter, Fc2, at step 734 and then returns to step 730. The calibration parameter Fc2 is set as the reverse force value Fp2 minus the force feedback value F2 (Fc2=Fp2-F2).

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

1. A main housing portion of a portable information handing system, comprising:
a bottom cover portion; and,
a top cover portion coupled to the bottom cover portion, the top cover portion comprising a top portion unibody cover, a clear mesh portion, the clear mesh portion performing a touch sensing operation and a top portion bottom cover, the top portion unibody cover and the clear mesh portion being fastened to the top portion bottom cover to provide a unibody top cover portion, the top cover portion corresponding to a C-Cover of the portable information handling system.

2. The main housing portion of claim 1, wherein:
the top cover portion further comprises a piezo portion, the piezo portion performing a haptic function.

3. The main housing portion of claim 2, wherein:
the haptic function is location specific, the haptic function providing localized haptic feedback for a full palm rest size trackpad.

4. The main housing portion of claim 1, wherein:
the top cover portion further comprises a film portion, the film portion performing a force sensing operation.

5. The main housing portion of claim 4, wherein:
the film portion is constructed of at least one of force sensing resistive film and a force sensing capacitive film.

6. The main housing portion of claim 1, wherein:
the top portion unibody cover comprises back printing, the back printing representing a plurality of keys of a keyboard.

7. An information handling system comprising:
a processor;
a data bus coupled to the processor; and
an information handling system chassis housing, the housing comprising
a base chassis, the base chassis housing the processor, the base chassis comprising
a bottom cover portion; and,
a top cover portion coupled to the bottom cover portion, the top cover portion comprising a top portion unibody cover, a clear mesh portion, the clear mesh portion performing a touch sensing operation and a top portion bottom cover, the top portion unibody cover and the clear mesh portion being fastened to the top portion bottom cover to provide a unibody top cover portion, the top cover portion corresponding to a C-Cover of the information handling system.

8. The information handling system of claim 7, wherein:
the top cover portion further comprises a piezo portion, the piezo portion performing a haptic function.

9. The information handling system of claim 8, wherein:
the haptic function is location specific, the haptic function providing localized haptic feedback for a full palm rest size trackpad.

10. The information handling system of claim 7, wherein:
the top cover portion further comprises a film portion, the film portion performing a force sensing operation.

11. The information handling system of claim 10, wherein:
the film portion is constructed of at least one of force sensing resistive film and a force sensing capacitive film.

12. The information handling system of claim 11, wherein:
the top portion unibody cover comprises back printing, the back printing representing a plurality of keys of a keyboard.
